(19) United States
(12) Patent Application Publication
(10) Pub. No.: US 2026/0126846 A1
(43) Pub. Date: May 7, 2026

(54) POWER REDUCTION DEVICE AND POWER REDUCTION METHOD

(71) Applicant: Nuvoton Technology Corporation, Hsinchu Science Park (TW)

(72) Inventor: Cheng-Chieh WANG, Hsinchu City (TW)

(21) Appl. No.: 19/346,930

(22) Filed: Oct. 1, 2025

(30) Foreign Application Priority Data
Nov. 7, 2024 (TW) 113142720

(51) Int. Cl. G06F 1/324

(52) U.S. Cl. CPC G06F 1/324

(57) ABSTRACT

A power reduction device includes a first master controller, a processor, and a power manager. The power manager includes a model acceleration algorithm. The first master controller is configured to output a first active transmission signal. The model acceleration algorithm is configured to control the clock source of the processor or the power supply of the processor to reduce the power consumption of the processor according to the first active transmission signal.

### CROSS REFERENCE TO RELATED APPLICATIONS

This Application claims priority of TW Patent Application No. 113142720, filed on November 07, 2024, the entirety of which is incorporated by reference herein.

### BACKGROUND OF THE INVENTION

### Field of the Invention

The present invention relates to a reduction device and reduction method, and, in particular, it is related to a power reduction device and power reduction method.

### Description of the Related Art

Currently, in low power consumption (low power) designs of microcontrollers (MCUs) and microprocessors (MPUs), software developers are required to have a certain level of familiarity with the voltage and power supply control of the target platform.

As a result, software developers need to spend time studying the specification sheets during program development, which also leads to more complex control-related code that is prone to unexpected errors, thereby increasing development costs and development time.

### BRIEF SUMMARY OF THE INVENTION

The summary of the invention is intended to provide a simplified overview of the present disclosure so that readers may have a basic understanding of the disclosure. This summary is not an exhaustive overview of the disclosure, nor is it intended to identify essential or key elements of the embodiments of the invention, or to define the scope of the invention.

An embodiment of the present invention provides a power reduction device. The power reduction device includes a first master controller, a processor, and a power manager. The power manager includes a model acceleration algorithm. The first master controller is configured to output a first active transmission signal. The model acceleration algorithm is configured to control a clock source of the processor or a power supply of the processor to reduce a power consumption of the processor according to the first active transmission signal.

In one embodiment, the first active transmission signal includes one of a peripheral direct memory access signal and a direct memory access signal; wherein the first master controller includes one of a direct memory access controller and a peripheral direct memory access controller; wherein the power reduction device includes a microcontroller, and the processor is disposed within the microcontroller.

In one embodiment, the power manager further includes an event fusion engine; wherein the event fusion engine is configured to outputs an integrated signal according to a plurality of signals; wherein the plurality of signals includes the first active transmission signal.

In one embodiment, the power manager further includes a neural network inference engine; wherein the neural network inference engine outputs a first relay signal or a second relay signal according to the integrated signal and the model acceleration algorithm.

In one embodiment, the power manager further includes a clock control logic; wherein the clock control logic adjusts a clock frequency of the processor according to the first relay signal.

In one embodiment, the power manager further includes a power supply control logic; wherein the power supply control logic adjusts a voltage of the processor according to the second relay signal.

In one embodiment, the power reduction device is used for a first platform and a second platform; wherein the model acceleration algorithm reduces the power consumption of the processor according to a first event of the first platform.

In one embodiment, the model acceleration algorithm reduces the power consumption of the processor according to a second event of the second platform; wherein the first platform and the second platform are different from each other.

Other embodiment of the present invention provides a power reduction method. The power reduction method includes the following steps: outputting a first active transmission signal by a first master controller; outputting a second active transmission signal by a second master controller; reducing a power consumption of the processor according to the first active transmission signal controls a clock source of the processor or a power supply of the processor; and reducing the power consumption of the processor according to the second active transmission signal controls the clock source of the processor or the power supply of the processor. The first active transmission signal and the second active transmission signal are not directly input to the processor. Each of the first master controller and the second master controller includes one of a direct memory access controller and a peripheral direct memory access controller.

In one embodiment, the power reduction method is executed by a microcontroller; wherein the processor, the first master controller, and the second master controller are disposed within the microcontroller.

In one embodiment, the power manager further comprises an event fusion engine; wherein the event fusion engine is configured to outputs an integrated signal according to a plurality of signals; wherein the plurality of signals comprises the first active transmission signal; wherein the first active transmission signal comprises one of a peripheral direct memory access signal and a direct memory access signal; wherein the first master controller comprises one of a direct memory access controller and a peripheral direct memory access controller.

In one embodiment, the power manager further comprises a neural network inference engine; wherein the neural network inference engine outputs a first relay signal or a second relay signal according to the integrated signal and the model acceleration algorithm.

In one embodiment, the power manager further comprises a clock control logic; wherein the clock control logic adjusts a clock frequency of the processor according to the first relay signal.

In one embodiment, the power manager further comprises a power supply control logic; wherein the power supply control logic adjusts a voltage of the processor according to the second relay signal.

In one embodiment, the power reduction device is used for a first platform and a second platform.

In one embodiment, the model acceleration algorithm reduces the power consumption of the processor according to a first event of the first platform.

In one embodiment, the model acceleration algorithm reduces the power consumption of the processor according to a second event of the second platform.

In one embodiment, the first platform and the second platform are different from each other.

Therefore, according to the technical content of the present disclosure, the power reduction device and power reduction method shown in the embodiment of the present disclosure can achieve the effect of low power consumption adjustment by enabling the processor to adjust power consumption in real time through a neural network model algorithm.

Upon reviewing the embodiments described below, a person of ordinary skill in the art will readily understand the basic spirit of the present invention, other objectives of the invention, as well as the technical means and embodiments adopted in the present invention.

Other features and aspects of the present disclosure will become apparent from the following detailed description of exemplary embodiments with reference to the accompanying drawings.

### BRIEF DESCRIPTION OF THE DRAWINGS

The views of the embodiments of the present disclosure can be better understood through the following detailed description combined with the accompanying drawings. It is worth noting that, according to standard industrial practice, some features may not be drawn to scale. In fact, to facilitate clear description, the dimensions of different features may be increased or decreased, wherein:

FIG. 1 is a block diagram of a power reduction device according to one embodiment of the present disclosure.

FIG. 2 is a block diagram of a power manager of a power reduction device according to one embodiment of the present disclosure.

FIG. 3 is a signal timing diagram of a plurality of signals of a power reduction device according to one embodiment of the present disclosure.

FIG. 4 is a flowchart of a power reduction method according to one embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In order to make the description of the present disclosure more detailed and complete, illustrative descriptions of embodiments and specific examples of the present invention are provided below; however, these are not the only forms for implementing or practicing the specific embodiments of the invention. The embodiments encompass features of multiple specific examples, as well as the method steps and their sequence for constructing and operating such specific examples. Nevertheless, other specific embodiments may also be employed to achieve the same or equivalent functions and sequences of steps.

Unless otherwise defined herein, the scientific and technical terms used in this specification have the same meanings as commonly understood by a person of ordinary skill in the art to which the present invention pertains. Furthermore, unless the context clearly indicates otherwise, the singular forms used herein are intended to include the plural, and the plural forms are intended to include the singular.

In addition, the terms “coupled” or “connected” as used herein may refer to direct physical or electrical contact between two or more components, indirect physical or electrical contact between two or more components, or cooperation or interaction between two or more components.

As used herein, the term “circuit” broadly refers to an object formed by one or more transistors and/or one or more passive or active components connected in a certain manner to process signals.

Certain terms are used in the specification and the claims to refer to specific elements. However, it will be understood by a person of ordinary skill in the art that the same element may be referred to by different names. Distinctions between elements in the specification and claims are not to be made based on differences in names, but rather on functional differences. The term “comprising” as used in the specification and the claims is intended to be an open-ended term, and should be interpreted as “including but not limited to.”

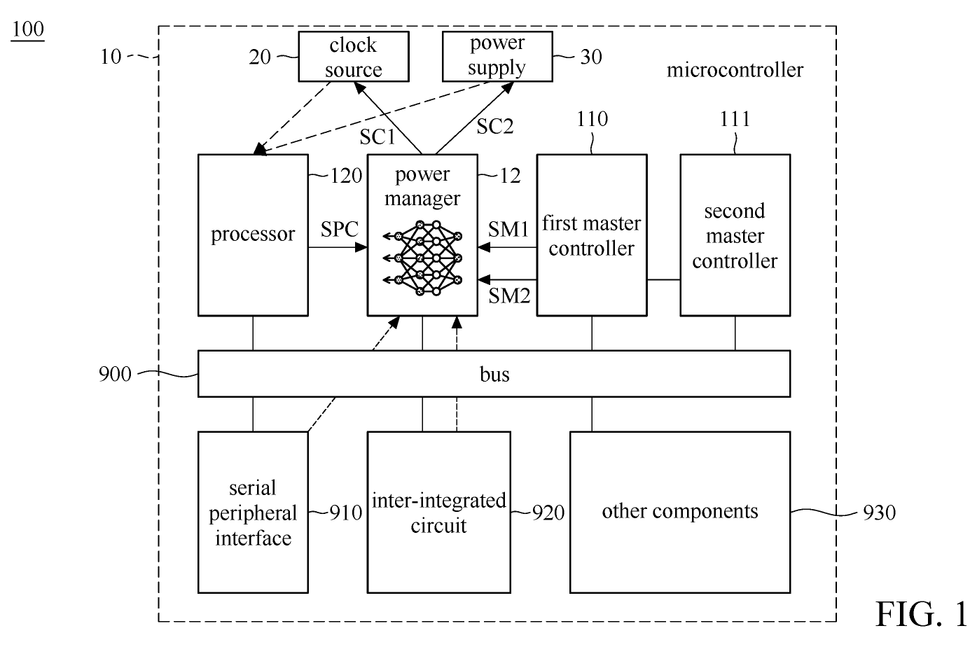

FIG. 1 is a block diagram of a power reduction device according to one embodiment of the present disclosure. As shown in the figure, in the embodiment, the power reduction device 100 includes a first master controller (Master) 110, a processor 120, and a power manager (or power management unit, PMU) 12. The first master controller 110 may be coupled to the power manager 12, the processor 120 may be coupled to the power manager 12, but the present disclosure is not limited thereto.

In some embodiments, power reduction device 100 further includes a microcontroller (Micro Control Unit, MCU) 10, a clock source 20, and a power supply 30. The clock source 20 may be coupled to the power manager 12, the power supply 30 may be coupled to the power manager 12, and the first master controller 110, the processor 120, the power manager 12, the clock source 20, and the power supply 30 may be disposed within the microcontroller 10. In some embodiments, the microcontroller 10 may be a microprocessor (Micro Processing Unit, MPU), but the present disclosure is not limited thereto.

For example, the processor 120 may be any type of processor within the microcontroller or the microprocessor, and the processor 120 may be primarily used for processing a plurality of signals within the microcontroller or the microprocessor, but the present disclosure is not limited thereto.

In some embodiments, the processor 120 may be one of a central processing unit (CPU) and a graphics processing unit (GPU), but the present disclosure is not limited thereto. In some embodiments, the processor 120 may be at least one CPU and/or at least one GPU, but the present disclosure is not limited thereto.

In this embodiment, the power manager 12 includes a model acceleration algorithm. For example, the model acceleration algorithm may be one of any type of artificial neural network (ANN) model, any type of big data algorithm, any type of machine learning algorithm, any type of artificial intelligence (AI) algorithm, and any type of Chat Generative Pre-trained Transformer (ChatGPT) algorithm, but the present disclosure is not limited thereto.

In this embodiment, the first master controller 110 is configured to output a first active transmission signal SM1. For example, the first master controller 110 may actively output the first active transmission signal SM1, and the first active transmission signal SM1 may be directly input to the power manager 12, but the present disclosure is not limited thereto. In some embodiments, the first active transmission signal SM1 may not be directly input to the processor 120, but the present disclosure is not limited thereto. In some embodiments, the first active transmission signal SM1 may be one of an interrupt signal and an event signal, but the present disclosure is not limited thereto.

In this embodiment, the model acceleration algorithm is configured to reduce a power consumption (power) of the processor 120 according to the first active transmission signal SM1 controls a clock source 20 of the processor 120 or a power supply 30 of the processor 120.

For example, upon receiving the first active transmission signal SM1, the model acceleration algorithm may be configured to control a signal provided from the clock source 20 to the processor 120, or to control a signal provided from the power supply 30 to the processor 120, but the present disclosure is not limited thereto. Furthermore, when the processor 120 reduces the clock frequency in response to a signal from the clock source 20, or when the processor 120 reduces the voltage in response to a signal from the power supply 30, the power consumption of the processor 120 may be reduced.

As a general matter, the processor 120 may constitute the component with the greatest power consumption within the microcontroller 10. Accordingly, reducing the power consumption of the processor 120 may effectively reduce the overall power consumption of the power reduction device 100.

In some embodiments, the processor 120 may output a program counter (PC) signal SPC to the power manager 12. In some embodiments, the output program counter signal SPC may serve as an important parameter for the model acceleration algorithm. For most of the time, the model acceleration algorithm may infer, based on the output program counter signal SPC, the execution position of the software (or algorithm) and determine whether to control or adjust the power manager 12, but the present disclosure is not limited thereto.

In some embodiments, the power reduction device 100 further includes a bus 900, a serial peripheral interface (SPI) 910, an inter-integrated circuit (I2C) 920, and other components (other slaves) 930. The serial peripheral interface 910 may be coupled to the bus 900, the inter-integrated circuit 920 may be coupled to the bus 900, and the other components 930 may be coupled to the bus 900.

In the embodiment, the first active transmission signal SM1 may be one of a peripheral direct memory access (PDMA) signal and a direct memory access (DMA) signal. The first master controller 110 may include one of a direct memory access controller and a peripheral direct memory access controller. The power reduction device 100 may include the microcontroller 10, with the processor 120 disposed within the microcontroller 10.

For example, the first active transmission signal SM1 and the second active transmission signal SM2 may each be the peripheral direct memory access signal or the direct memory access signal, the first master controller 110 and the second master controller 111 may each be the direct memory access controller or the peripheral direct memory access controller, but the present disclosure is not limited thereto.

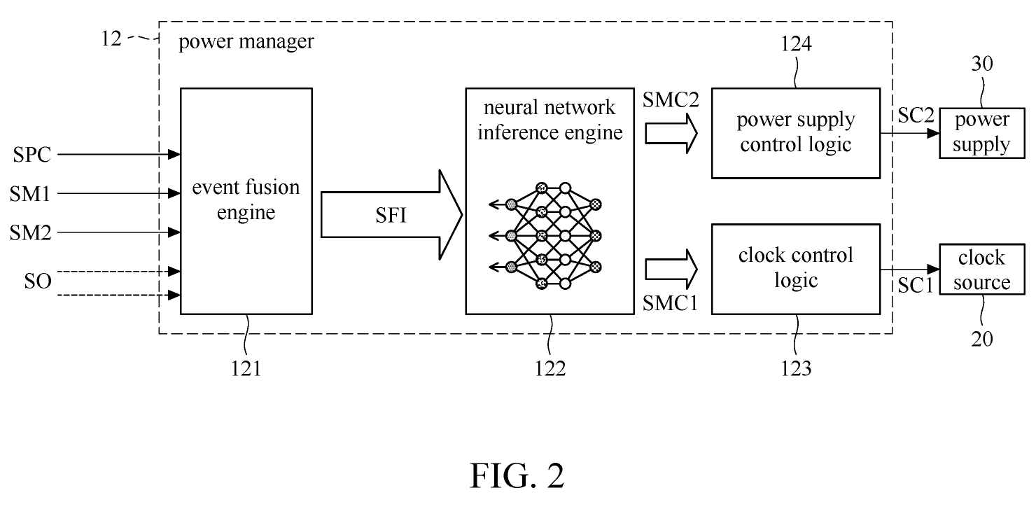

FIG. 2 is a block diagram of a power manager of a power reduction device according to one embodiment of the present disclosure. In some embodiments, the power manager 12 shown in FIG. 2 may correspond to the power manager 12 shown in FIG. 1.

Please refer to FIG. 1 and FIG. 2, in the embodiment, the power manager 12 further includes an event fusion engine (Event Fusion Engine) 121, the event fusion engine 121 is configured to outputs an integrated signal SFI according to a plurality of signals. The event fusion engine 121 is configured to receive the plurality of signals. The plurality of signals includes the first active transmission signal SM1.

For example, the event fusion engine 121 of the power manager 12 may be configured to receive messages from the processor 120, the first master controller 110, the second master controller 111, or other components 930 (such as a program counter signal SPC, a first active transmission signal SM1, a second active transmission signal SM2, or other signals SO), and integrate them to output data in a predetermined format (such as an integrated signal SFI), but the present disclosure is not limited thereto. In addition, the event fusion engine 121 may be implemented as a software, a firmware, or a hardware component to realize the above-described technical features, but the present disclosure is not limited thereto. In some embodiments, the other components 930 may output the other signals SO. In the embodiment, the integrated signal SFI may serve as a general data transmission interface, and the data in a predetermined format may integrate the received information into a set of vector data, for example, a formatted input data, but the present disclosure is not limited thereto.

In the embodiment, the power manager 12 further includes a neural network inference engine (neural network inference engine) 122, the neural network inference engine 122 outputs a first relay signal SMC1 or a second relay signal SMC2 according to the integrated signal SFI and the model acceleration algorithm.

For example, the neural network inference engine 122 may output a first relay signal SMC1 or a second relay signal SMC2 according to the integrated signal SFI and/or the model acceleration algorithm. In some embodiments, the neural network inference engine 122 may be the model acceleration algorithm, but the present disclosure is not limited thereto. In some embodiments, the neural network inference engine 122 may control the following clock control logic 123 and/or power supply control logic 124 to output a first control signal SC1 or a second control signal SC2 according to the integrated signal SFI and/or the model acceleration algorithm. In addition, the neural network inference engine 122 may be implemented as a software, a firmware, or a hardware component to realize the above-described technical features, but the present disclosure is not limited thereto.

In the embodiment, the power manager 120 further includes a clock control logic (Clock control logic) 123, the clock control logic 123 controls and adjusts the clock frequency of the processor 120 according to the first relay signal SMC1.

For example, the clock control logic 123 may output a first control signal SC1 to the clock source 20 so as to control and adjust a clock frequency (also referred to as a magnitude of the clock frequency) of the processor 120 according to the first relay signal SMC1, but the present disclosure is not limited thereto.

In the embodiment, the power manager 120 further includes a power supply control logic (Power control logic) 124, the power supply control logic 124 controls and adjust a voltage of the processor 120 according to second relay signal SMC2.

For example, the power supply control logic 124 may output a second control signal SC2 to the power supply 30 so as to control and adjust a voltage (also referred to as a magnitude of the voltage) of the processor 120 according to the second relay signal SMC2, but the present disclosure is not limited thereto.

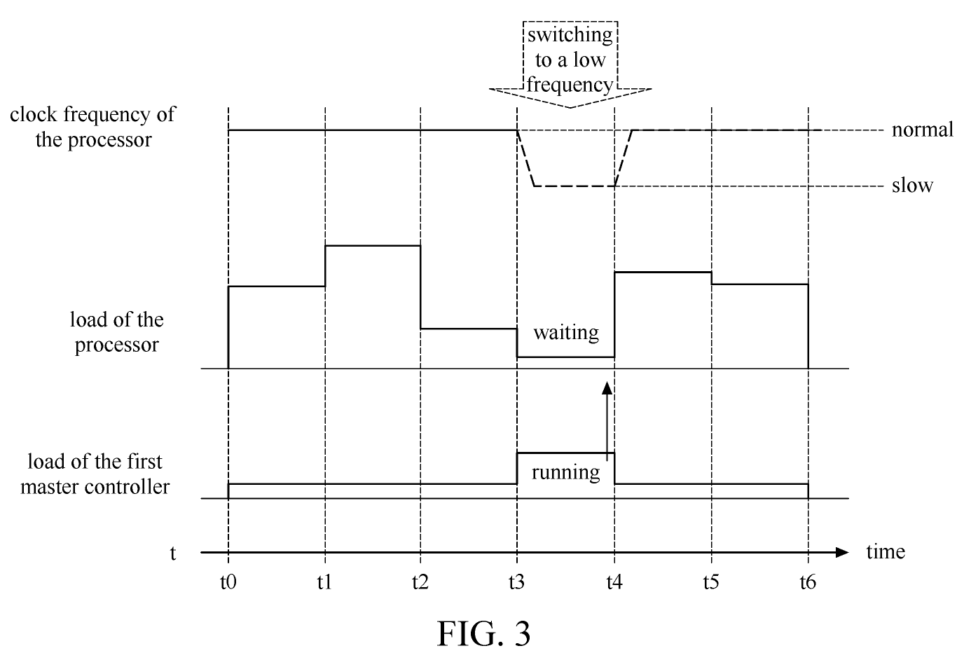

FIG. 3 is a signal timing diagram of a plurality of signals of a power reduction device according to one embodiment of the present disclosure. As shown in the figure, FIG. 3 may illustrate the signal timing relationships of respective periods t0 to t6 with the clock frequency of the processor 120, a load of the processor 120, and a load of the first master controller 110, but the present disclosure is not limited thereto.

Please refer to FIG. 1 and FIG. 3, in some embodiments, the plurality of periods t0 to t2 and t5 to t6 correspond to normal operation of the processor 120. In the period t3, the first master controller 110 may operate and output the first active transmission signal SM1. Meanwhile, the model acceleration algorithm of the power manager 12 reduces the clock frequency of the processor 120 according to the first active transmission signal SM1, thereby further decreasing a load of the processor 120 and causing the processor 120 to enter a waiting (or sleep) mode.

In some embodiments, in the period t4, the first master controller 110 may output an interrupt signal to the model acceleration algorithm of the power manager 12 to wake up the processor 120, allowing the processor 120 to operate normally, but the present disclosure is not limited thereto.

In the embodiment, the power reduction device 100 is used for a first platform and a second platform. The model acceleration algorithm reduces the power consumption of the processor 120 according to a first event of the first platform. In the embodiment, the model acceleration algorithm reduces the power consumption of the processor 120 according to a second event of the second platform. The first platform and the second platform are different from each other.

For example, the first platform may be a Microsoft Windows operating system platform, and the second platform may be a Linux operating system platform. The first event of the first platform may be any event that does not require the processor 120 to operate or perform any action, and the second event of the second platform may be any event that does not require the processor 120 to operate or perform any action, but the present disclosure is not limited thereto.

In detail, the model acceleration algorithm may be used across platforms, and the model acceleration algorithm may further update itself according to a first event of the first platform or a second event of the second platform, so as to better match operations on the first platform or the second platform. When the power reduction device 100 is used with the first platform or the second platform, the power reduction device 100 may achieve a low power consumption design effect through the model acceleration algorithm.

In some embodiments, the operations of the second master controller 111 are similar to the operations of the first master controller 110, and for the sake of conciseness of the present specification, detailed descriptions thereof are omitted herein.

In some embodiments, the model acceleration algorithm of the present disclosure may be constructed based on C language, but the present disclosure is not limited thereto. In some embodiments, the model acceleration algorithm of the present disclosure may be trained by means of a software language framework and operations without requiring training through a physical system architecture, but the present disclosure is not limited thereto.

In some embodiments, the model acceleration algorithm of the present disclosure may select periods in which power supply or clock operations are to be controlled based on assembly machine code segments of a processor (such as the processor 120 or another processor).

In this embodiment, the model acceleration algorithm of the present disclosure may integrate and tag data to form a dataset suitable for training, and use the trained dataset to train a model.

Furthermore, the training phase may be divided into a plurality of stages. For example, the plurality of stages may sequentially include a processor program code (CPU program code) stage, an assembly machine code stage, a dataset stage, a tagged dataset stage, and a model training stage, but the present disclosure is not limited thereto. In addition, the plurality of stages may be arbitrarily reordered according to requirements, but the present disclosure is not limited thereto.

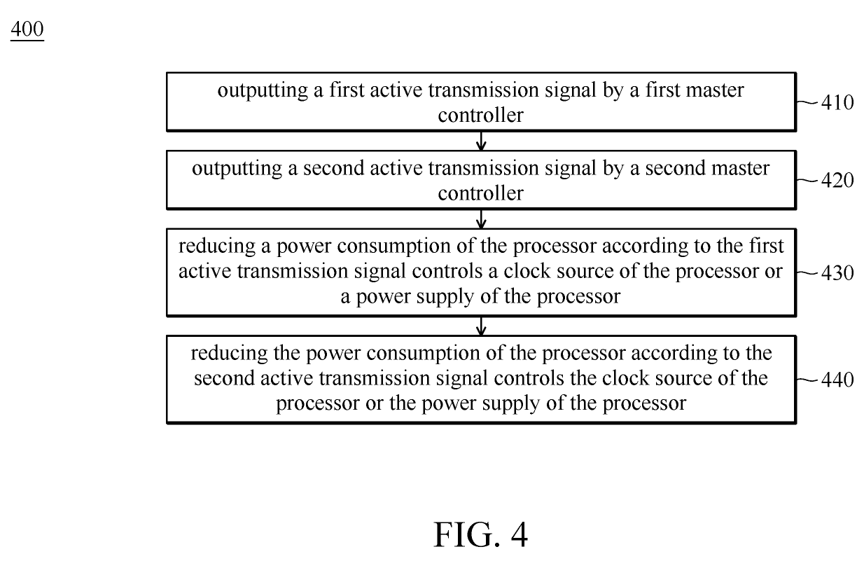

FIG. 4 is a flowchart of a power reduction method according to one embodiment of the present disclosure. As shown in the figure, the power reduction method 400 includes a plurality of steps 410 to 440. Please refer to FIG. 1 and FIG. 4. Detailed step-by-step procedures or operational descriptions are provided in the following description.

In the step 410, outputting a first active transmission signal by a first master controller.

In the embodiment, the first active transmission signal SM1 may be output by the first master controller 110. In some embodiments, the first active transmission signal SM1 may be directly output to the power manager 12 by the first master controller 110.

In the step 420, outputting a second active transmission signal by a second master controller.

In the embodiment, the second active transmission signal SM2 may be output by the second master controller 111. In some embodiments, the second master controller 111 may be configured to directly output the second active transmission signal SM2 to the power manager 12. In some embodiments, the step 420 may be performed after the step 410. In some embodiments, the step 420 may be performed concurrently with the step 410.

In the step 430, reducing a power consumption of the processor according to the first active transmission signal controls a clock source of the processor or a power supply of the processor.

In the embodiment, the model acceleration algorithm may reduce the power consumption of the processor 120 according to the first active transmission signal SM1 controls the clock source 20 of the processor 120 or the power supply 30 of the processor 120. In some embodiments, the step 430 may be performed after the step 410, but the present disclosure is not limited thereto.

In the step 440, reducing the power consumption of the processor according to the second active transmission signal controls the clock source of the processor or the power supply of the processor.

In the embodiment, the model acceleration algorithm may reduce the power consumption of the processor 120 according to the second active transmission signal SM2 controls the clock source 20 of the processor 120 or the power supply 30 of the processor 120. In some embodiments, the step 440 may be performed after the step 450, but the present disclosure is not limited thereto.

In the embodiment, in the power reduction method 400, the first active transmission signal SM1 and the second active transmission signal SM2 are not directly input to the processor 120. Each of the first master controller 110 and the second master controller 111 includes one of a direct memory access controller and a peripheral direct memory access controller.

In the embodiment, the power reduction method 400 is executed by a microcontroller 10, and the processor 120, the first master controller 110, and the second master controller 111 are disposed within the microcontroller 10.

In some embodiments, the power reduction method 400 may be performed by the power reduction device 100, a non-transitory computer-readable storage medium, or other devices or systems, but the present disclosure is not limited thereto.

In some embodiments, the plurality of steps 410 to 440 of the power reduction method 400 may be performed in any order, but the present disclosure is not limited thereto. In some embodiments, a user may insert additional operational steps into any of the plurality of steps 410 to 440 of the power reduction method 400 to meet requirements, but the present disclosure is not limited thereto.

Therefore, according to the technical content of the present disclosure, the power reduction device and power reduction method shown in the embodiment of the present disclosure can achieve the effect of low power consumption adjustment by enabling the processor to adjust power consumption in real time through a neural network model algorithm.

Furthermore, after completing training during the training phase, the model acceleration algorithm of the present disclosure may autonomously learn and adapt across different platforms, so that cross-platform usage can still achieve low power consumption adjustment.

Moreover, through the model acceleration algorithm of the present disclosure, related software developers do not need to have detailed knowledge of voltage or power supply control of the target platform. The model acceleration algorithm can autonomously handle learning and updating to achieve low power consumption adjustment, thereby reducing development costs and development time.

Although the specific embodiments of the present disclosure have been described above, they are not intended to limit the present disclosure. Those skilled in the art may make various modifications and alterations without departing from the principles and spirit of the present disclosure. Therefore, the scope of the present disclosure should be defined by the appended claims.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power reduction device, comprising:
a first master controller, configured to output a first active transmission signal;
a processor; and
a power manager, comprising:
a model acceleration algorithm, configured to control a clock source of the processor or a power supply of the processor to reduce a power consumption of the processor according to the first active transmission signal.

2. The power reduction device as claimed in claim 1, wherein
the first active transmission signal comprises one of a peripheral direct memory access signal and a direct memory access signal;
wherein the first master controller comprises one of a direct memory access controller and a peripheral direct memory access controller;
wherein the power reduction device comprises a microcontroller, and the processor is disposed within the microcontroller.

3. The power reduction device as claimed in claim 1, wherein
the power manager further comprises an event fusion engine;
wherein the event fusion engine is configured to outputs an integrated signal according to a plurality of signals;
wherein the plurality of signals comprises the first active transmission signal.

4. The power reduction device as claimed in claim 3, wherein
the power manager further comprises a neural network inference engine;
wherein the neural network inference engine outputs a first relay signal or a second relay signal according to the integrated signal and the model acceleration algorithm.

5. The power reduction device as claimed in claim 4, wherein
the power manager further comprises a clock control logic;
wherein the clock control logic adjusts a clock frequency of the processor according to the first relay signal.

6. The power reduction device as claimed in claim 4, wherein
the power manager further comprises a power supply control logic;
wherein the power supply control logic adjusts a voltage of the processor according to the second relay signal.

7. The power reduction device as claimed in claim 1, wherein
the power reduction device is used for a first platform and/or a second platform.

8. The power reduction device as claimed in claim 7, wherein
the model acceleration algorithm reduces the power consumption of the processor according to a first event of the first platform.

9. The power reduction device as claimed in claim 8, wherein
the model acceleration algorithm reduces the power consumption of the processor according to a second event of the second platform;
wherein the first platform and the second platform are different from each other.

10. A power reduction method, comprising:
outputting a first active transmission signal by a first master controller;
outputting a second active transmission signal by a second master controller;
reducing a power consumption of a processor according to the first active transmission signal controls a clock source of the processor or a power supply of the processor; and
reducing the power consumption of the processor according to the second active transmission signal controls the clock source of the processor or the power supply of the processor;
wherein the first active transmission signal and the second active transmission signal are not directly input to the processor;
wherein each of the first master controller and the second master controller comprises one of a direct memory access controller and a peripheral direct memory access controller.

11. The power reduction method as claimed in claim 10, wherein
the power reduction method is executed by a microcontroller;
wherein the processor, the first master controller, and the second master controller are disposed within the microcontroller.

12. The power reduction method as claimed in claim 10, wherein
a power manager further comprises an event fusion engine;
wherein the event fusion engine is configured to outputs an integrated signal according to a plurality of signals;
wherein the plurality of signals comprises the first active transmission signal;
wherein the first active transmission signal comprises one of a peripheral direct memory access signal and a direct memory access signal.

13. The power reduction method as claimed in claim 12, wherein
the power manager further comprises a neural network inference engine;
wherein the neural network inference engine outputs a first relay signal or a second relay signal according to the integrated signal and a model acceleration algorithm.

14. The power reduction method as claimed in claim 13, wherein
the power manager further comprises a clock control logic;
wherein the clock control logic adjusts a clock frequency of the processor according to the first relay signal.

15. The power reduction method as claimed in claim 13, wherein
the power manager further comprises a power supply control logic;
wherein the power supply control logic adjusts a voltage of the processor according to the second relay signal.

16. The power reduction method as claimed in claim 10, wherein
the power reduction method is used for a first platform and/or a second platform.

17. The power reduction method as claimed in claim 16, wherein
a model acceleration algorithm reduces the power consumption of the processor according to a first event of the first platform and/or a second event of the second platform.

18. The power reduction method as claimed in claim 17, wherein
the first platform and the second platform are different from each other.
